(19) United States
(12) Patent Application Publication
(10) Pub. No.: US 2026/0128709 A1
(43) Pub. Date: May 7, 2026

(54) COUNTERBALANCE ASSEMBLIES IN PHOTOVOLTAIC SOLAR TRACKERS

(71) Applicant: ARRAY TECH, Inc., Albuquerque, NM (US)

(72) Inventors: Kevin Krautbauer, Phoenix, AZ (US); Benjamin C. De Fresart, Chandler, AZ (US)

(21) Appl. No.: 19/374,657

(22) Filed: Oct. 30, 2025

Related U.S. Application Data
(60) Provisional application No. 63/715,341, filed on Nov. 1, 2024.

(51) Int. Cl. H02S 20/32

(52) U.S. Cl. CPC H02S 20/32

(57) ABSTRACT

A counterbalance assembly in a photovoltaic tracking system may include a top bracket secured to a torque tube such that the top bracket rotates with the torque tube about an axis of rotation between a first rotational limit in a first direction and a second rotational limit in a second direction. The assembly may include a bottom bracket secured to a column supporting the torque tube and a stretchable member with a top end connected to the top bracket and a bottom end connected to the bottom bracket. The assembly may include a means for limiting a restorative force applied by the stretchable member to less than a threshold level while the torque tube is between the first and second rotational limits. The means may include a pin-and-slot connection in the top and/or bottom brackets or a linkage between the stretchable member and the top and/or bottom brackets.

### CROSS-REFERENCE TO RELATED APPLICATIONS

This patent application claims priority to and the benefit of U.S. Provisional Patent Application Ser. No. 63/715,341, entitled COUNTERBALANCE ASSEMBLIES IN PHOTOVOLTAIC SOLAR TRACKERS, filed Nov. 1, 2024, which is incorporated by reference in its entirety.

### FIELD

The present disclosure relates to solar energy production and more particularly to counterbalance assemblies for decreasing the moment force exerted on a torque tube at high tilt angles.

### BACKGROUND

Solar installations including solar farms, photovoltaic (PV) plants, solar tracking systems, fixed solar systems, and other PV systems often include large numbers of PV modules that collect sunlight and generate energy. In solar tracking systems, PV modules are supported by horizontal support structures, or torque tubes, which rotate so that the PV modules may be oriented at various tilt angles to follow a position of the Sun as it moves throughout the day.

PV modules are often left vulnerable to the elements because of the tilt angles at which the modules operate. As most PV modules utilize glass to encase the PV cells, hail is a significant threat to solar installations. For example, hail may shatter the glass, damage the PV cells, and cause unseen damage that may reduce the effectiveness of the PV module.

One technique for mitigating hail damage is to position the PV modules at steeper tilt angles—or stow the PV modules at higher angles—during a hailstorm. PV modules that are positioned horizontally (with 0° tilt angles) are subject to direct or nearly direct impact from falling hail and the forces that result. Stowing the modules at steeper angles may reduce the impact force of the hail relative to horizontal tilt angles thereby creating glancing blows instead of direct impacts. A steeper tilt angle results in a less direct impact from falling hail. Additionally, stowing the modules at higher angles reduces the effective area of glass that is exposed to the hail. Thus, stowing the modules at higher angles may reduce the extent of damage that may be caused by a hailstorm and may render the PV module more effective over a longer period of time.

In many solar tracker systems, counterbalance assemblies may create forces that assist the PV modules in returning the PV modules to lower tilt angles or horizontal from stow configurations. As the torque tube is rotated, a moment force may be created about the center of the rotation axis, which increases as the tilt angle increases. The amount and direction of this moment force is determined by the weight of the PV modules, which creates a rotational force on the torque tube in the direction of the PV modules, and by the counterbalance assembly, which creates a rotational force in an opposite direction. As the tilt angle increases, the moment created by the counterbalance assembly also increases. At steep tilt angles, however, (such as hail-stow angles) the moment load created by the counterbalance assembly may exceed the rotational force created by the PV modules. While the torque tube rotates to stow the modules, the counterbalance assembly may effectively be influencing or pulling the modules back toward horizontal. The amount of pull created by the counterbalance assembly at these steep tilt angles may be sufficiently strong to damage components of the tracking system and/or prevent the tracking system from achieving a hail-stow position, leaving the PV modules at a more shallow angle and more vulnerable to hail damage.

Accordingly, there is a need for a counterbalance assembly that reduces the rate at which a restorative force created by a counterbalance assembly increases when PV modules are stowed at steeper angles. As a result, steeper tilt angles may be achieved, and PV modules may suffer less damage during a hailstorm.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Exemplary embodiments of the present disclosure address problems experienced in solar tracking systems, including problems associated with stowing PV modules at higher tilt angles. Embodiments disclosed herein address these issues by providing a counterbalance assembly with a means for limiting a restorative force applied to the torque tube to less than a threshold level while the torque tube is between the rotational limits of the PV tracking system, which may allow for higher stow angles to be achieved.

The counterbalance assembly may include a top bracket which is configured to be secured to a torque tube such that the top bracket rotates with the torque tube about an axis of rotation between the rotational limits of the PV tracking system. The counterbalance assembly may also include a bottom bracket configured to be secured to a column (or pile) supporting the torque tube. The counterbalance assembly may further include a stretchable member having a top end that is connected to the top bracket and a bottom end that is connected to the bottom bracket. In some embodiments, the stretchable member may be a spring. In some embodiments, the spring may be a progressive spring, a digressive spring, or a linear spring.

The counterbalance assembly may further include a means for limiting a restorative force applied by the stretchable member to less than a threshold level while the torque tube is between the rotational limits of the PV tracking system. This may allow for higher stow angles to be achieved. In some embodiments, the means for limiting the restorative force may include a pin and slot connection. The stretchable member may be connected to a pin that is positioned within a slot in the top and/or the bottom bracket. The pin and slot connection may allow a connection point between the stretchable member and the top and/or bottom brackets to move within the slot to reduce the rate of the restorative force applied by the stretchable member as the torque tube rotates towards the rotational limits of the PV tracking system.

In some embodiments, the means for limiting the restorative force may include a linkage positioned between the stretchable member and the top and/or bottom brackets. The linkage may be secured to the top and/or bottom brackets through a pivot joint. As the torque tube rotates towards the rotational limits of the PV tracking system, a connection point between the stretchable member and the linkage may pivot about the pivot joint in a rotational direction that is opposite to the rotation of the torque tube. In these and other embodiments, the counterbalance assembly may include one or more stops which prevent the linkage from moving when the torque tube rotates past a rotational threshold. For example, a first stop may be included on a first side of the linkage and a second stop may be included on a second side of the linkage.

In some embodiments, the counterbalance assembly may include the top bracket, the bottom bracket, and a variable-rate spring. The variable rate spring may be connected to the top bracket at a top end of the spring and connected to the bottom bracket at a bottom end of the spring. The variable-rate spring may have multiple spring rates. A first spring rate may be active from the start of the rotation of the torque tube until an activation angle is reached at which point a second spring rate may be activated. The first spring rate, the second spring rate, and the activation angle may limit a restorative force applied by the variable-rate spring to the torque tube to maintain the restorative force between a minimum restorative force and a maximum restorative force at angles greater than or equal to the activation angle and while the torque tube is between the rotational limits of the PV tracking system.

Thus, the embodiments disclosed may improve solar panel tracking systems by limiting the restorative force applied by counterbalance assemblies such that higher stow angles may be achieved. This may, for example, allow the PV modules to be stowed at higher angles without causing damage to tracking system components during hailstorms. As a result, PV modules may experience less damage.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 illustrates an example photovoltaic system utilizing a counterbalance assembly;

FIG. 2A illustrates a front-view of an example counterbalance assembly with a pin and slot connection for limiting a restorative force applied by a stretchable member of the counterbalance assembly;

FIG. 2B illustrates an exploded view of the example counterbalance assembly of FIG. 2A;

FIGS. 2C-2E illustrate the example counterbalance assembly of FIG. 2A at varying tilt angles;

FIG. 2F illustrates a front-view of the example counterbalance assembly of FIG. 2A without dampers;

FIG. 3 is a chart showing the effect of the counterbalance assembly of FIGS. 2A-2F on a restorative force applied by the stretchable member of the counterbalance assembly at varying tilt angles;

FIGS. 4A and 4B illustrate an example counterbalance assembly with a pin and slot connection for limiting a restorative force applied by a stretchable member of the counterbalance assembly;

FIG. 4C illustrates an exploded view of the example counterbalance assembly of FIGS. 4A and 4B;

FIGS. 5A-5C illustrate an example counterbalance assembly with an asymmetric pin and slot connection at varying tilt angles in a first direction;

FIGS. 5D-5E illustrate the example counterbalance assembly of FIGS. 5A-5C with an asymmetric pin and slot at varying tilt angles in a second direction;

FIG. 6A is a chart showing the effect of the example counterbalance assembly of FIGS. 5A-5E on a restorative force applied by a stretchable member of the counterbalance assembly at varying tilt angles in the first direction;

FIG. 6B is a chart showing the effect of the example counterbalance assembly of FIGS. 5A-5E on the restorative force applied by the stretchable member of the counterbalance assembly at varying tilt angles in the second direction;

FIG. 7A illustrates a front-view of an example counterbalance assembly with a linkage for limiting a restorative force applied by a stretchable member of the counterbalance assembly;

FIG. 7B illustrates a perspective view of the example counterbalance assembly of FIG. 7A;

FIGS. 7C and 7D illustrate the example counterbalance assembly of FIG. 7A at varying tilt angles;

FIG. 8 illustrates the effect of the example counterbalance assembly of FIGS. 7A-7D on a restorative force applied by a stretchable member of the counterbalance assembly at varying tilt angles;

FIG. 9A illustrates a front-view of an example counterbalance assembly with a variable-rate spring;

FIG. 9B-9D illustrate the example counterbalance assembly of FIG. 9A at varying tilt angles;

FIG. 10 is a chart showing the effect of the example counterbalance assembly of FIGS. 9A-9D on a restorative force applied by the variable-rate spring where the variable-rate spring is a digressive spring; and

FIG. 11 is a chart showing the effect the example counterbalance assembly of FIGS. 9A-9D has on a restorative force applied by the variable-rate spring where the variable-rate spring is a progressive spring.

All in accordance with one or more embodiments in the present disclosure.

### DETAILED DESCRIPTION

Embodiments of the present disclosure are explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

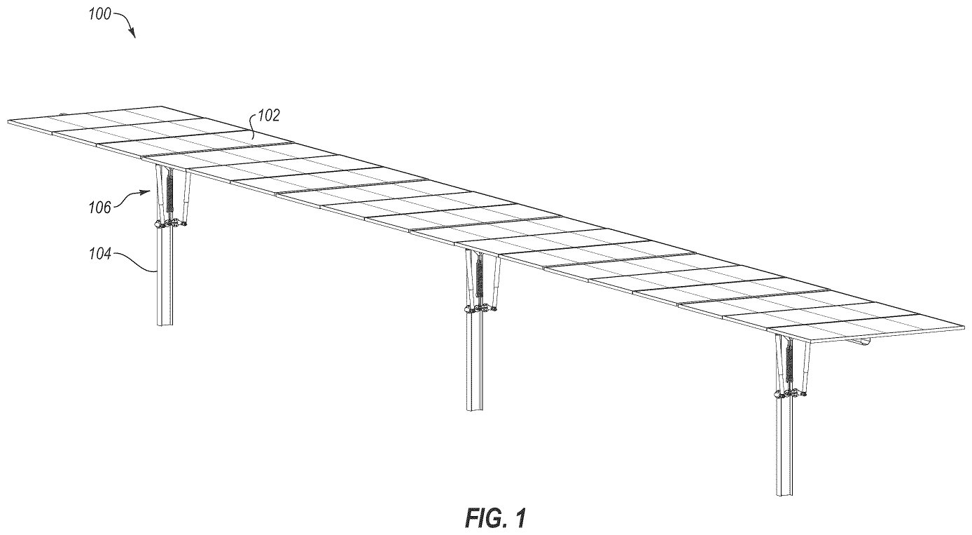

FIG. 1 illustrates an example photovoltaic system 100. The example photovoltaic system 100 may include PV modules 102, a support column (or pile) 104, a counterbalance assembly 106, and a torque tube (not shown). The support column 104 may be driven into the ground and may provide vertical support for the torque tube and the PV modules 102. The counterbalance assembly 106 may also be secured to the support column 104. The torque tube may provide horizontal support to the PV modules 102 and the torque tube may be rotated by a motor (not shown). The PV modules 102 may be attached to the torque tube such that the rotation of the torque tube may be translated to the PV modules 102 enabling the PV modules 102 to track the position of the Sun in the sky throughout the day. For example, as the Sun rises and early in the day, the PV modules 102 may be rotated by the torque tube such that the PV modules 102 are facing an easterly direction, around mid-day the PV modules 102 may be horizontal, and, as the Sun sets and later in the day, the PV modules 102 may be rotated by the torque tube such that the PV modules 102 are facing a westerly direction.

The counterbalance assembly 106 may include a bottom bracket which may secure the counterbalance assembly 106 to the support column 104. The counterbalance assembly 106 may include a top bracket (not shown) which may secure the counterbalance assembly 106 to the torque tube.

The top bracket of the counterbalance assembly 106 may rotate with the torque tube about an axis of rotation between a first rotational limit in a first direction and a second rotational limit in a second direction. In some embodiments, the axis of rotation may be the center of the torque tube. For example, the example photovoltaic system 100 may have a first rotational limit in a clockwise direction of rotation about the center of the torque tube and a second rotational limit in a counterclockwise direction of rotation about the center of the torque tube.

In some embodiments, the first and the second rotational limits may be the same. In some embodiments, the first and second rotational limits may be different. For example, the first rotational limit may be larger than the second rotational limit or the second rotational limit may be larger than the first rotational limit. In some embodiments, the first and/or second rotational limits may be greater than 50 degrees from horizontal, greater than 55 degrees from horizontal, greater than 60 degrees from horizontal, greater than 65 degrees from horizontal, greater than 70 degrees from horizontal, greater than 75 degrees from horizontal, greater than 80 degrees from horizontal, greater than 85 degrees from horizontal, or the first and/or second rotational limits may be equal to 90 degrees. While reference is made to the first and/or second rotational limits being measured from horizontal for purposes of clarity, it will be appreciated that the first and/or second rotational limits may be measured from any reference angle.

The counterbalance assembly 106 may also include a stretchable member. In some embodiments, the stretchable member may be a spring, an elastic cord, a belt, a strap, a tube, a coil, a cable, or any other stretchable member. In embodiments where the stretchable member is a spring, the stretchable member may be a linear spring or a variable-rate spring like a digressive or a progressive spring. In these and other embodiments, the stretchable member may be a compression spring or a tension spring.

The stretchable member may include a top end that is connected to the top bracket and a bottom end that is connected to the bottom bracket. The stretchable member may apply a restorative force to the torque tube as the torque tube rotates between the first and second rotational limits. For example, the stretchable member may be a compression spring and, as the torque tube rotates clockwise, the spring may be compressed, and the spring may apply a moment force to the torque tube in a counterclockwise direction such that the torque tube is influenced to rotate in the counterclockwise direction.

Generally, unless the restorative force is limited, the restorative force will increase as the torque tube rotates and approaches the first and second rotational limits. For example, the stretchable member may be a compression spring, the restorative force may increase as the torque tube rotates and the spring continues to be compressed, and the restorative force may reach a maximum at the first rotational limit. Thus, unless the restorative force is limited, the restorative force influences the torque tube to rotate in the opposite direction more as the torque tube gets closer to the first and/or second rotational limits.

In some embodiments, the counterbalance assembly 106 may include a means for limiting the restorative force applied by the stretchable member to the torque tube to less than a threshold level while the torque tube is between the first and second rotational limits. In some embodiments, the threshold force may be less than 600 N-m, less than 700 N-m, less than 800 N-m, less than 1000 N-m, less than 1100 N-m, less than 1200 N-m, less than 1300 N-m, less than 1400 N-m, less than 1500 N-m, less than 1600 N-m, less than 1700 N-m, less than 1800 N-m, less than 1900 N-m, less than 2000 N-m, or any other threshold force. In some embodiments, the means for limiting the restorative force may be a pin and slot connection, a linkage, a cam, a hinge, a swivel, or other equivalents which may reduce or limit the restorative force to less than a threshold level.

In some embodiments, the means for limiting the restorative force may include a pin and slot connection. In these embodiments, the stretchable member may be connected to a pin that is positioned within a slot in the top and/or bottom brackets. The pin and slot connection may allow a connection point between the stretchable member and the top and/or bottom brackets to move within the slot to reduce a rate at which the restorative force increases as the torque tube rotates.

In some embodiments, the means for limiting the restorative force may include a linkage. In these embodiments, the linkage may be positioned between the stretchable member and the top and/or bottom bracket. The linkage may be secured to the top and/or bottom brackets through a pivot joint. As the torque tube rotates toward the first and second rotational limits, a connection point between the stretchable member and the linkage may pivot in a rotational directional that is opposite to a rotational direction of the torque tube. For example, if the torque tube is rotating in a clockwise direction the connection point between the stretchable member and the linkage may pivot in a counterclockwise direction about the pivot joint and vice versa.

In some embodiments, the counterbalance assembly 106 may include a variable rate spring. The variable-rate spring may have a top end connected to the top bracket and a bottom end connected to the bottom bracket. The variable-rate spring may have a first spring rate and a second spring rate. The first spring rate may be active from the start of torque tube rotation until an activation angle is reached. The second spring rate may be activated when the activation angle is reached. The first spring rate, the second spring rate, and the activation angle may be configured such that a restorative force applied by the variable-rate spring to the torque tube is maintained between a minimum restorative force and a maximum restorative force at angles greater than or equal to the activation angle and while the torque tube is between the first and second rotational limits. In some embodiments, the variable-rate spring may be the stretchable member.

Modifications, additions, or omissions may be made to the example photovoltaic system 100 without departing from the scope of the present disclosure. For example, multiple PV modules 102, multiple support columns 104, and/or multiple counterbalance assemblies 106 may be used in the example system. As shown in FIG. 1, the counterbalance assembly 106 is used on every support column 104; however, in some embodiments, the counterbalance assembly 106 may not be used on every support column 104. For example, the counterbalance assembly 106 may be used on every other support column 104, or every third support column 104, at any other interval, or at any other spacing in the example photovoltaic system 100.

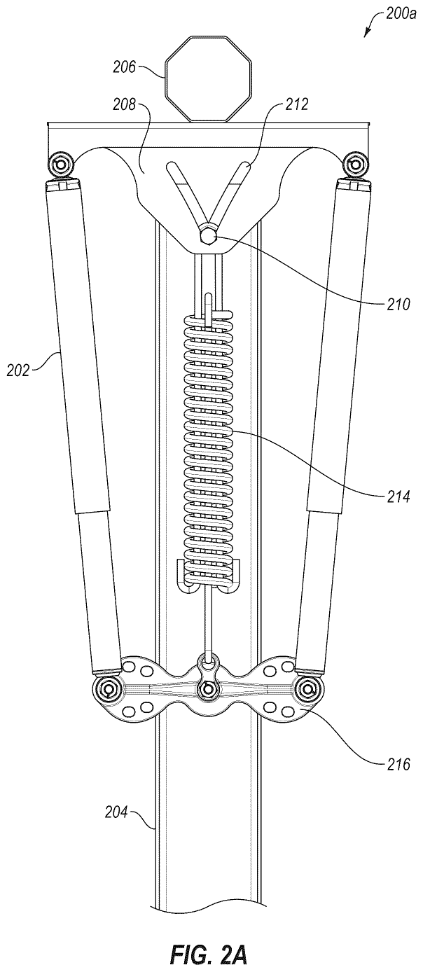

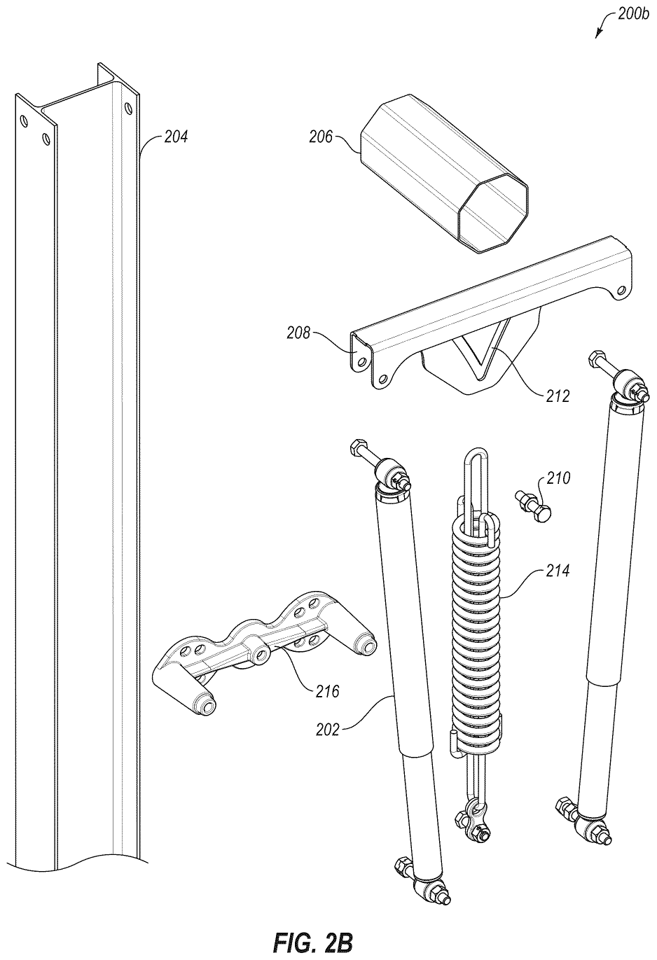

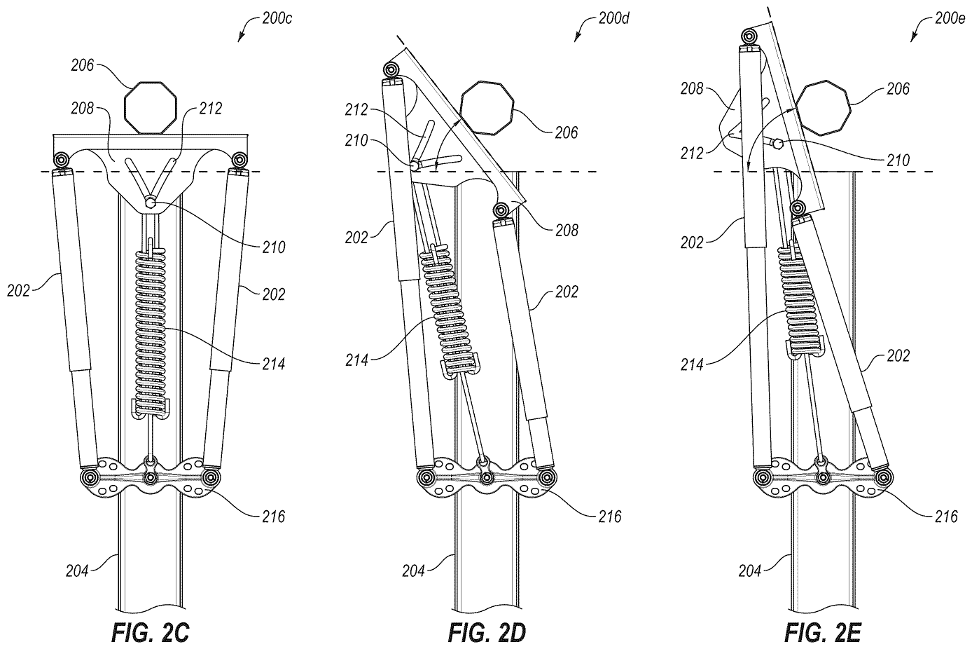

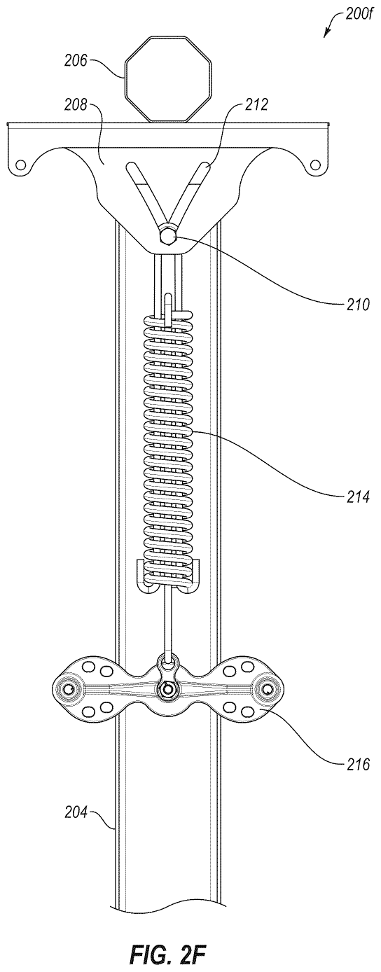

FIGS. 2A and 2B respectively illustrate a front-view of an example counterbalance assembly 200 utilizing a pin and slot connection as a means for limiting the restorative force applied by a stretchable member 214 and an exploded view of the example counterbalance assembly 200. The example counterbalance assembly 200 includes a top bracket 208, a pin 210, a slot 212, a stretchable member 214, and a bottom bracket 216. There are also optional dampers 202 connected to the top and bottom brackets 208 and 216.

The counterbalance assembly 200 may be secured to a torque tube 206 via the top bracket 208, and the top bracket 208 may rotate with the torque tube 206 about an axis of rotation between a first rotational limit in a first direction and a second rotational limit in a second direction. The axis of rotation may be the center of the torque tube 206. The counterbalance assembly 200 may be secured to a support column 204 via the bottom bracket 216.

The damper 202 may include a top end attached to the top bracket 208 and a bottom end attached to the bottom bracket 216. In some embodiments, the damper 202 may be a hydraulic damper, a pneumatic damper, a friction damper, a magnetic damper, or any other suitable damper. As shown in FIGS. 2A and 2B, a first damper 202 may be on one side of the stretchable member 214 and another damper 202 may be on the other side of the stretchable member 214.

The stretchable member 214 may include a top end connected to the top bracket 208 and a bottom end connected to the bottom bracket 216. As shown in FIGS. 2A and 2B, the stretchable member 214 is a linear, compression spring; however, the stretchable member 214 may be a tension spring, any other type of spring (e.g. digressive variable-rate spring, progressive variable-rate spring), an elastic cord, a belt, a strap, a tube, a coil, a cable, or any other stretchable member.

In some embodiments, the top bracket 208 and/or the bottom bracket 216 may include a pin and slot connection including a pin 210 and a slot 212. The pin and slot connection including the pin 210 and the slot 212 may be a means for limiting the restorative force applied by the stretchable member 214 to the torque tube 206 to less than a threshold level while the torque tube 206 is between the first and second rotational limits.

The pin 210 may be positioned within the slot 212 and the stretchable member 214 may be connected to the pin 210. The pin 210 may be any suitable fastener capable of joining the top bracket 208 and/or the bottom bracket 216 to the stretchable member 214. For example, the pin 210 may be an elongated rod, a bolt, a screw, a cotter pin, a clevis pin, a roll pin, a hairpin, a wheel, or any other fastener capable of joining the top bracket 208 and/or the bottom bracket 216 to the stretchable member 214.

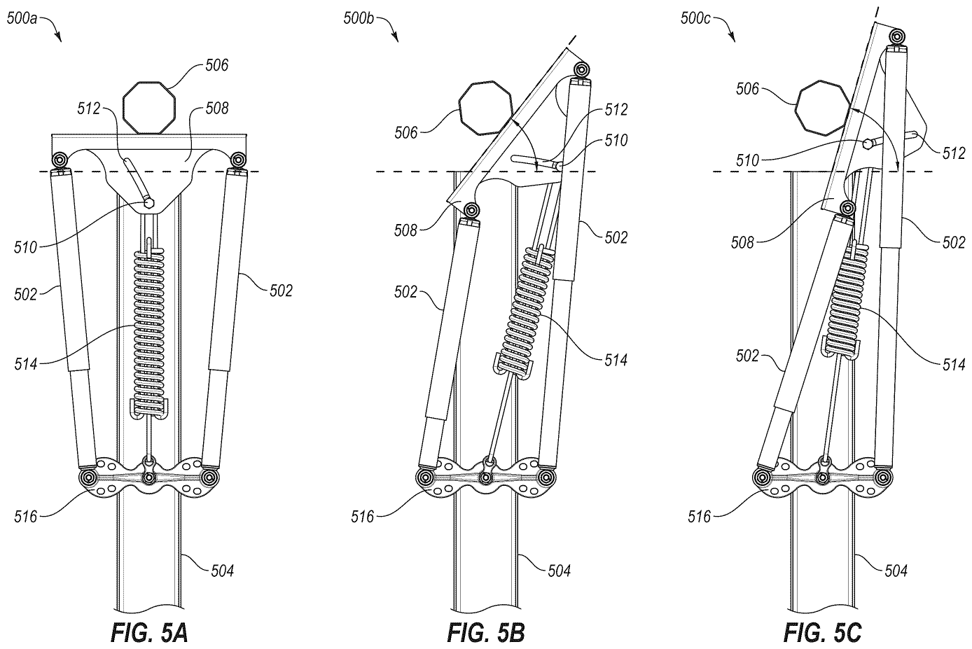

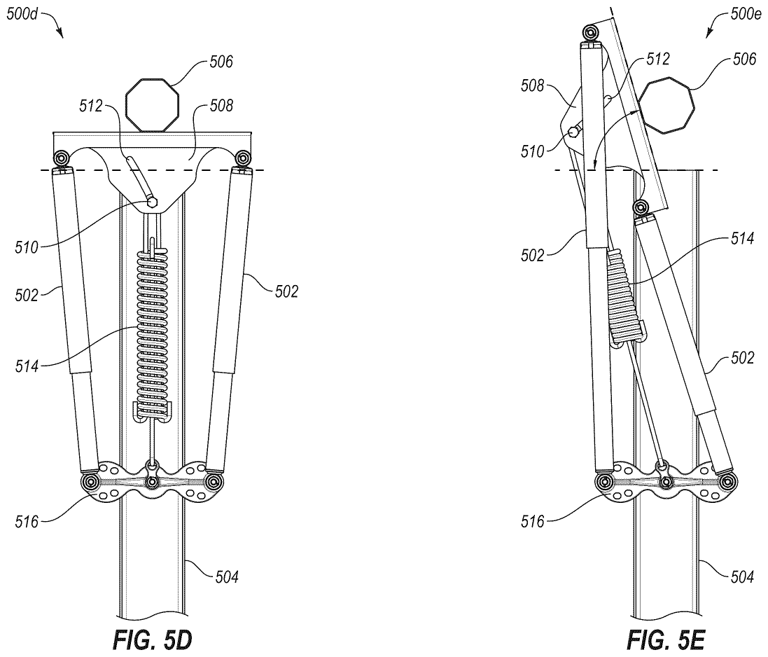

The slot 212 may be defined in the top bracket 208 and/or the bottom bracket 216. In some embodiments, the slot 212 may be symmetric about a vertical axis and may take on any suitable shape. For example, the slot 212 may be V-shaped (as shown in counterbalance assembly 200), U-shaped, partially O-shaped (with the one side on a top-half of the “O” not connecting to the other side on the top-half of the “O”), or any other symmetric shape. In some embodiments and as explained in more detail with reference to FIGS. 5A-5E, the slot 212 may be asymmetric.

The pin and slot connection may allow the connection point between the stretchable member 214 and the pin 210 to move within the slot 212 such that a rate at which the restorative force applied by the stretchable member 214 is reduced as the torque tube 206 moves toward the first or second rotational limits. In some embodiments, the movement of the pin 210 within the slot 212 may reduce a distance between the center of the torque tube 206 and the force applied by the stretchable member 214 thereby reducing the restorative force and/or the movement of the pin 210 within the slot 212 may change the angle at which the restorative force of the stretchable member 214 acts on the torque tube 206. In these and other embodiments, the pin and slot connection may limit the restorative force applied by the stretchable member 214 to less than a threshold level. For example, the pin and slot connection may limit the restorative force applied by the stretchable member 214 to less than 1000 N-m, less than 2000 N-m, or some other force. An example of the pin 210 moving in the slot 212 as the torque tube 206 rotates toward the first or second rotational limits is shown in FIGS. 2C-2E.

FIGS. 2C-2E illustrate the example counterbalance assembly 200 of FIGS. 2A and 2B at varying tilt angles. FIG. 2C shows the counterbalance assembly 200c at horizontal where the torque tube 206 has not begun rotation in either direction. FIG. 2D shows the counterbalance assembly 200d at a tilt angle where the torque tube 206 has begun rotation, but the pin 210 has not yet moved within the slot 212. FIG. 2E shows the counterbalance assembly 200e at a tilt angle where the pin 210 has moved within the slot 212 to reduce a rate at which the restorative force increases as the torque tube 206 rotates toward the first or second rotational limits and to limit the restorative force to less than a threshold level.

As shown in FIGS. 2C-2E, the slot 212 is an upward-facing V shape. In counterbalance assembly 200c, the pin 210 connecting the stretchable member 214 to the slot 212 in the top bracket 208 is positioned at the base of the V-shaped slot 212 when the counterbalance assembly 200c is horizontal.

As the torque tube 206 rotates, the stretchable member 214 may apply a restorative force to the torque tube 206. As shown in FIGS. 2C-2E, the stretchable member 214 is a compression spring, which may compress as the torque tube 206 rotates, in turn applying an increasing restorative force to the torque tube 206. For at least some of the rotation of the torque tube 206, the pin 210 may remain in the position the pin 210 started when the counterbalance assembly 200 was horizontal. For example, the counterbalance assembly 200d demonstrates that, as the torque tube 206 rotates, the pin 210 may stay in the base of the V-shaped slot 212.

However, as the torque tube 206 continues to rotate to increase the tilt angle, the pin 210 may shift or otherwise move within the slot 212. As shown in the counterbalance assembly 200e, the pin 210 moves to the upper-right hand portion of the V-shaped slot 212 once a certain tilt angle and/or restorative force is reached as the torque tube 206 continues to rotate in the clockwise direction. The movement of the pin 210 in the slot 212 may limit the restorative force applied to the torque tube 206 by the stretchable member 214. In some embodiments, the pin 210 may move to the upper-left hand portion of the V-shaped slot once a certain tilt angle and/or restorative force is reached as the torque tube 206 rotates in the counterclockwise direction.

Modifications, additions, or omissions may be made to the example counterbalance assembly 200 without departing from the scope of the present disclosure. For example, in some embodiments, the damper 202 may be omitted. For example, counterbalance assembly 200f of FIG. 2F illustrates that the dampers 202 may be omitted. The counterbalance assembly 200f may perform the same or similar functions as the counterbalance assemblies 200a-e despite the dampers 202 being omitted. Additionally, either or both of the top bracket 208 and the bottom bracket 216 may include the pin 210 and the slot 212.

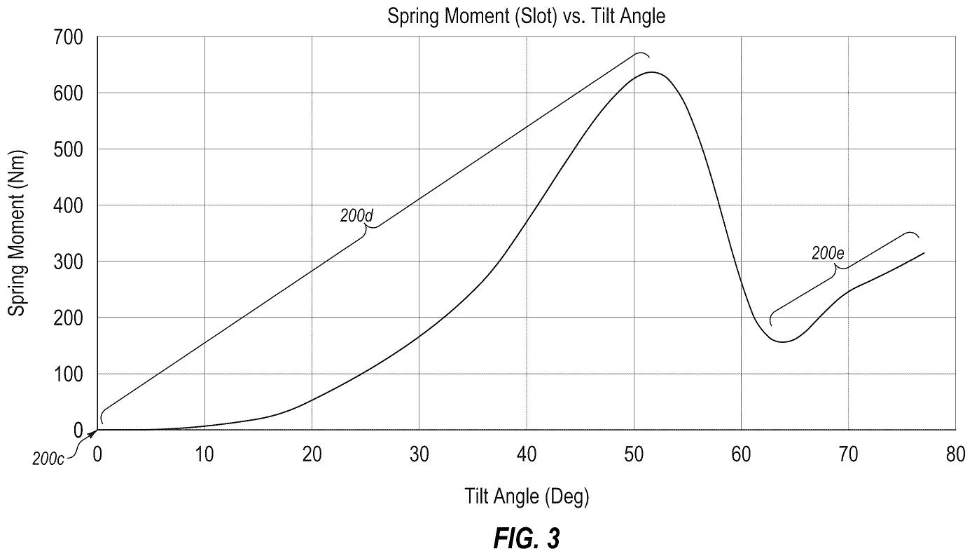

FIG. 3 is a chart showing the effect of the example counterbalance assembly 200 on the restorative force applied by the stretchable member 214 at varying tilt angles. As shown, the starting point is a tilt angle of 0 degrees, which may correspond to the counterbalance assembly 200c of FIG. 2. At horizontal, the restorative force of the stretchable member 214 may be 0 or negligent because the weight of the modules may be supported by the support column 204 and the torque tube 206 may not have begun rotation at this point.

As the torque tube 206 rotates, the restorative force of the stretchable member 214 may increase as the tilt angle increases. Up until a specific tilt angle, the pin 210 may stay in the same position the pin 210 started in allowing the restorative force applied by the stretchable member 214 to increase. For example, the pin 210 may remain positioned in the base of the slot 212 just as the pin 210 was in counterbalance assembly 200d.

However, once the pin 210 moves in the slot 212, the rate at which the restorative force increases as the torque tube 206 rotates toward the first or second rotational limits may be reduced. As shown in FIG. 3, the movement of the pin 210 within the slot 212 is demonstrated by the decrease in the restorative force after about 52 degrees. The restorative force then continues to increase, but, despite the higher tilt angle, the restorative force is lower than the restorative force was before the pin 210 shifted within the slot 212. In addition, the rate at which the restorative force applied by the stretchable member 214 increases as the torque tube 206 rotates is lower than the rate at which the restorative force increased before the pin 210 shifted within the slot 212. In FIG. 3, the pin 210 is shown to shift within the slot 212 at 52 degrees for illustrative purposes; however, it will be appreciated that the pin 210 may be configured to shift within the slot 212 at other tilt angles. A counterbalance assembly having a force profile as illustrated in FIG. 3 would be useful in a system where the threshold amount of force applied by the counterbalance assembly is 700 Nm or more, as the force applied is below this amount.

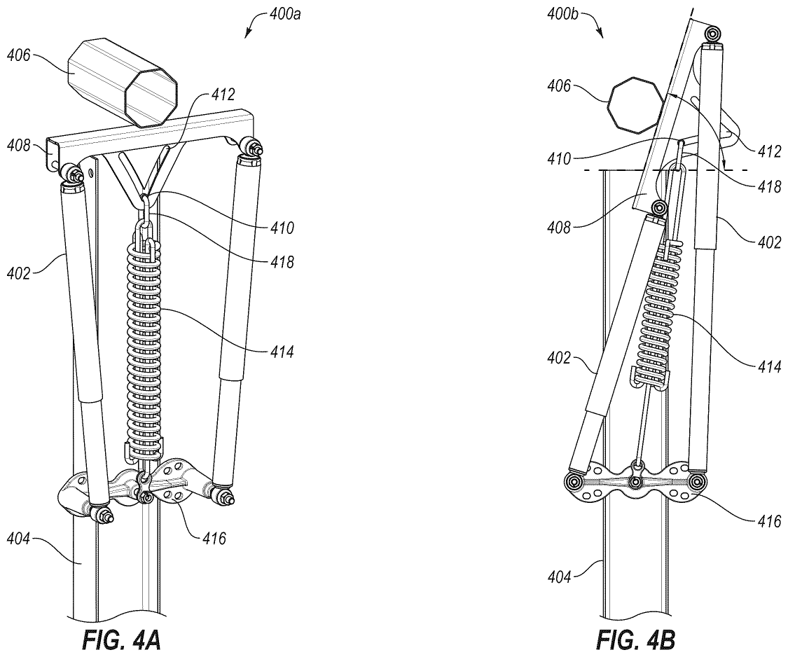

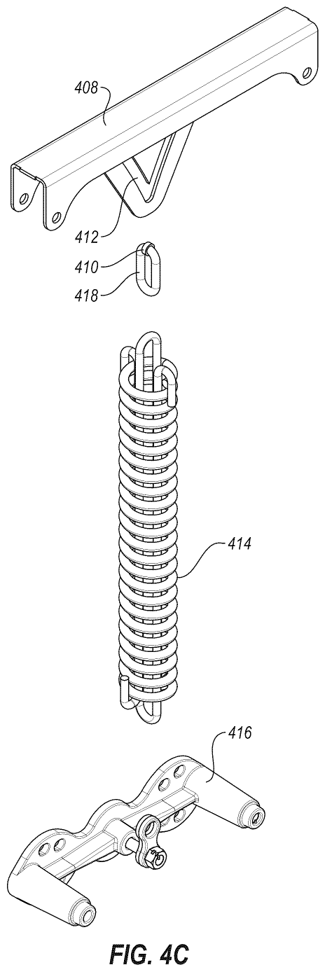

FIGS. 4A and 4B illustrate an example counterbalance assembly 400 with a pin and slot connection for limiting a restorative force applied by a stretchable member 414. FIG. 4C illustrates an exploded view of the example counterbalance assembly 400. The counterbalance assembly 400 includes a top bracket 408, a pin 410, a slot 412, a stretchable member 414, a bottom bracket 416, and a link 418. There are also optional dampers 402 connected to the top and bottom brackets 408 and 416. The top bracket 408 may be secured to a torque tube 406, and the top bracket 408 may rotate with the torque tube 406 about an axis of rotation between a first rotational limit in a first direction and a second rotational limit in a second direction. The bottom bracket 416 may be secured to a support column 404. The components depicted in counterbalance assembly 400 may be similar to and perform similar functions as similarly named components described throughout this disclosure.

As shown in FIG. 4A-4C, the pin 410 may be a wheel, which may provide a rolling interface between the stretchable member 414 and the slot 412. For example and as shown in FIG. 4B, the pin 410 may roll in the slot 412 to the upper-left hand portion of the V-shaped slot 412 once a certain tilt angle and/or restorative force is reached as the torque tube 406 continues to rotate in the counterclockwise direction. The movement of the pin 410 in the slot 412 may limit and/or reduce the restorative force applied to the torque tube 406 by the stretchable member 414. In some embodiments, the pin 410 may roll to the upper-right hand portion of the V-shaped slot once a certain tilt angle and/or restorative force is reached as the torque tube 406 rotates in the clockwise direction.

In these and other embodiments, the pin 410 may be connected to the stretchable member 414 via the link 418. In these embodiments, the link 418 may be a chain-link, a cable, loop, shackle, band, or any other connector capable of connecting the stretchable member 414 to the pin 410. In some embodiments, the pin 410 may include the wheel and the link 418.

Modifications, additions, or omissions may be made to the example counterbalance assembly 400 without departing from the scope of the present disclosure. For example, the damper 402 may be omitted. Additionally, either or both of the top bracket 408 and the bottom bracket 416 may include the pin 410 and the slot 412. In some embodiments, the link 418 may be omitted and the stretchable member 414 may be connected directly to the pin 410.

FIGS. 5A-5E illustrate an example counterbalance assembly 500 with an asymmetric pin and slot connection at varying tilt angles. The counterbalance assembly 500 may include an asymmetric pin and slot connection as a means for limiting a restorative force applied by a stretchable member 514. The asymmetric pin and slot connection may include a pin 510 and a slot 512. The counterbalance assembly 500 may include a top bracket 508, the pin 510, the slot 512, a stretchable member 514, and a bottom bracket 516. There are also optional dampers 502 connected to the top and bottom brackets 508 and 516. The top bracket 508 may be secured to a torque tube 506 such that the top bracket 508 rotates with the torque tube 506 about an axis of rotation between a first rotational limit in a first direction and a second rotational limit in a second direction. The bottom bracket 516 may be secured to a support column 504. The components depicted in counterbalance assembly 500 may be similar to and perform similar functions as similarly named components described throughout this disclosure.

The slot 512 may be an asymmetric slot. In some embodiments, the slot 512 may be asymmetric about a vertical axis centered with the top bracket 508 and/or the bottom bracket 516. In some embodiments, the slot 512 may be positioned on one side of the vertical axis. For example, the slot 512 may be positioned on the left side of the vertical axis as shown in FIGS. 5A-5E or the slot 512 may be positioned on the right side of the vertical axis. In some embodiments, the slot 512 may be positioned on both sides of the vertical axis, but may still be asymmetric. For example, the slot 512 may have a half-U shape on one side of the vertical axis and a half-V shape on the other side of the vertical axis.

The asymmetry of the slot 512 may allow a connection point between the pin 510 and the stretchable member 514 to move within the slot 512 in a first direction of rotation, but to remain still in a second direction of rotation. Thus, in the first direction of rotation a rate at which a restorative force is applied by the stretchable member 514 to the torque tube 506 may be reduced as the torque tube 506 rotates in the first direction by the pin 510 moving within the slot 512. For example, the movement of the pin 510 within the slot 512 may reduce a distance between the center of the torque tube 506 and the force applied by the stretchable member 514 thereby reducing the restorative force and/or the movement of the pin 510 within the slot 512 may change the angle at which the restorative force of the stretchable member 514 acts on the torque tube 506. In some embodiments, the pin and slot connection may limit the restorative force to less than a threshold level while the torque tube 506 is between a first rotational limit in the first direction and a second rotational limit in the second direction.

In the second direction of rotation, the rate at which the restorative force increases may stay the same or may increase as the torque tube 506 rotates because the pin 510 may remain in the same position. In addition, the asymmetric pin and slot connection may limit the restorative force applied by the stretchable member 514 to less than a threshold level in the first direction, but may not limit the restorative force applied by the stretchable member 514 to less than a threshold level in the second direction. For example, the pin and slot connection may limit the restorative force applied by the stretchable member 514 to less than 1000 N-m, less than 2000 N-m, or some other force only in the first direction.

In some embodiments, the slot 512 may be straight. In some embodiments, the slot 512 may be curved. In some embodiments, the stretchable member 514 may be a spring, an elastic cord, a belt, a strap, a tube, a coil, a cable, or any other stretchable member. In embodiments where the stretchable member 514 is a spring, the stretchable member 514 may be a linear spring or a variable-rate spring like a digressive or a progressive spring. In some embodiments, the stretchable member 514 may be a compression spring or a tension spring.

FIGS. 5A-5C illustrate the example counterbalance assembly 500 at varying tilt angles in the first direction. At a horizontal angle, the pin 510 may be positioned within the base of the slot 512 as shown in counterbalance assembly 500a. The torque tube 506 may rotate in the first direction (shown in FIG. 5B to be counterclockwise) and the pin 510 may remain in the same position until a tilt angle and/or restorative force applied by the stretchable member 514 is reached. Once the tilt angle and/or restorative force is reached and as shown in counterbalance assembly 500c, the connection point between the pin 510 and the stretchable member 514 may move within the slot 512 to reduce the rate at which the restorative force applied by the stretchable member 514 increases.

FIGS. 5D-5E illustrate the counterbalance assembly 500 at varying tilt angles in the second direction. FIG. 5D, like FIG. 5A, shows the counterbalance assembly 500d at a horizontal angle, where the pin 510 may be positioned in the base of the slot 512. The counterbalance assembly 500e shows the position of the pin 510 as the torque tube 506 rotates in the second direction (shown in FIG. 5E to be clockwise). In this embodiment, the pin 510 stays in place in the base of the slot 512, and the restorative force applied by the stretchable member 514 may continue to increase as the torque tube 506 rotates in the second direction.

Thus, FIGS. 5A-5E cumulatively demonstrate that, in some embodiments, the counterbalance assembly 500 may allow movement of the pin 510 within the slot 512 as the counterbalance assembly 500 rotates in the first direction, but may not allow movement of the pin 510 within the slot 512 as the counterbalance assembly 500 rotates in the second direction.

Modifications, additions, or omissions may be made to the example counterbalance assembly 500 without departing from the scope of the present disclosure. For example, the damper 502 may be omitted. Additionally, either or both of the top bracket 508 and the bottom bracket 516 may include the pin 510 and the slot 512.

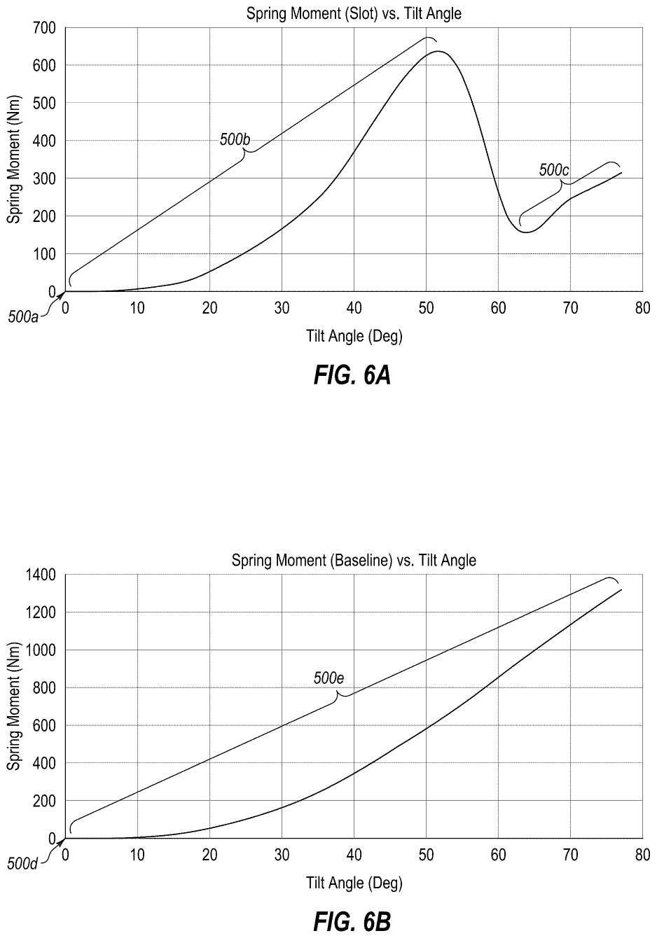

FIG. 6A is a chart showing the effect of the example counterbalance assembly 500a-500c of FIGS. 5A-5C on a restorative force applied by the stretchable member 514 at varying tilt angles in the first direction. FIG. 6A may have an identical or similar shape to that of FIG. 3. As shown, the starting point is a tilt angle of 0 degrees, which may correspond to the counterbalance assembly 500a of FIG. 5A. At horizontal, the restorative force of the stretchable member 514 may be 0 or negligent because the weight of the modules may be supported by the support column 504 and the torque tube 506 may not have begun rotation at this point.

As the torque tube 506 rotates in the first direction, the restorative force of the stretchable member 514 may increase as the tilt angle increases. Up until a specific tilt angle and/or restorative force, the pin 510 may stay in the same position the pin 510 started in allowing the restorative force from the stretchable member 514 to increase. For example, the pin 510 may remain positioned in the base of the slot 512 just as the pin 510 shown in counterbalance assembly 500b.

However, once the pin 510 moves in the slot 512, the rate at which the restorative force increases as the torque tube 506 rotates in the first direction may be reduced. The movement of the pin 510 within the slot 512 is demonstrated in FIG. 6A by the decrease in the restorative force at about 52 degrees. Once the pin 510 has moved within the slot 512, the restorative force may continue to increase, but, despite the higher tilt angle, the restorative force may be lower than the restorative force before the pin 510 shifted within the slot 512. In addition, the rate at which the restorative force increases as the torque tube 506 rotates may be lower than the restorative force rate before the pin 510 shifted within the slot 512. This effect is demonstrated in FIG. 6A by the area corresponding to counterbalance assembly 500c. In FIG. 6A, the pin 510 is shown to shift within the slot 512 at about 52 degrees for illustrative purposes, and it will be appreciated that the pin 510 may be configured to shift within the slot 512 at other tilt angles and/or restorative forces.

FIG. 6B is a chart showing the effect of the example counterbalance assembly 500 on a restorative force applied by the stretchable member 514 at varying tilt angles in the second direction. As shown, the starting point is a tilt angle of 0 degrees, which may correspond to the counterbalance assembly 500d of FIG. 5D. At horizontal, the restorative force of the stretchable member 514 may be 0 or negligent because the weight of the modules may be supported by the support column 504 and the torque tube 506 may not have begun rotation at this point.

Because of the asymmetric design of the pin and slot connection in the counterbalance assembly 500, the pin 510 may not shift within the slot 512 in the second direction. Hence, as the torque tube 506 rotates in the second direction, the pin 510 may stay positioned in the same place within the slot 512. Thus, the restorative force applied by the stretchable member 514 may increase as the tilt angle increases as shown by the area of FIG. 6B corresponding to counterbalance assembly 500e. In addition, the rate of change of the restorative force may also increase as the tilt angle increases. This effect is also demonstrated in FIG. 6B by the area corresponding to counterbalance assembly 500e.

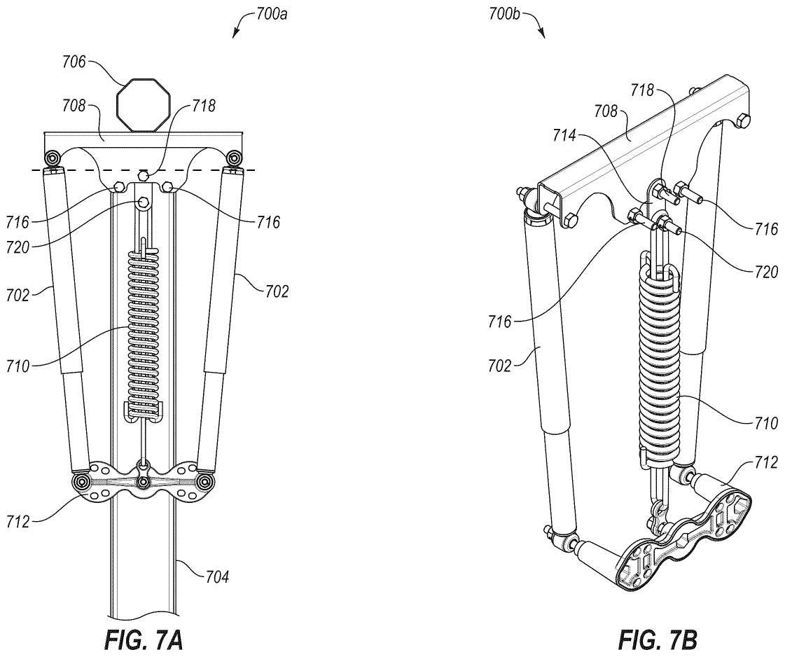

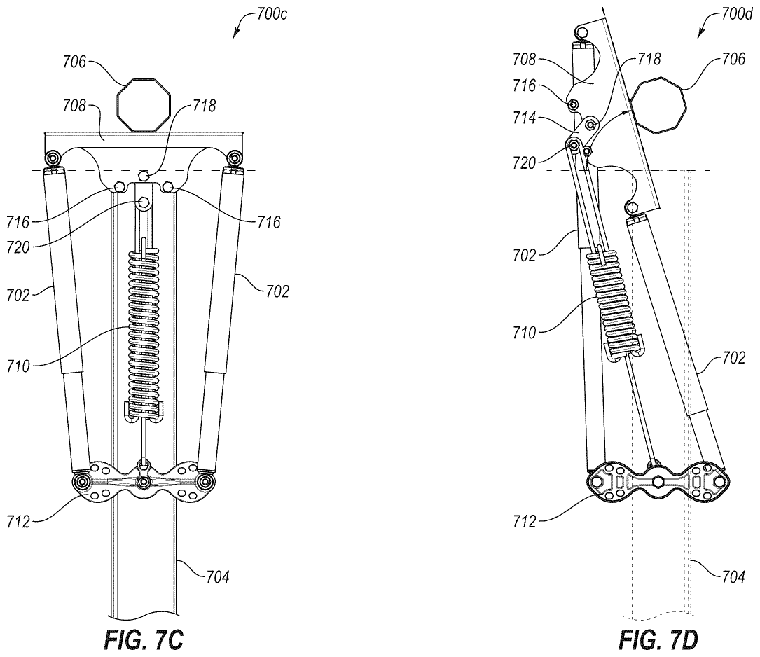

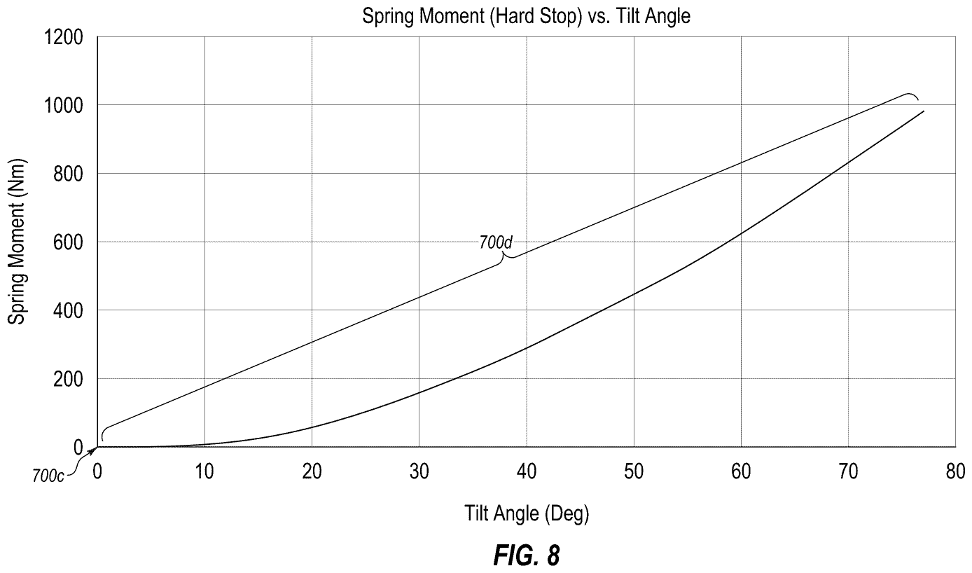

FIG. 7A and FIG. 7B respectively illustrate a front-view and a perspective view of an example counterbalance assembly 700 with a linkage 714 as a means for limiting a restorative force applied by a stretchable member 710 of the counterbalance assembly 700. The counterbalance assembly 700 may include a top bracket 708, the stretchable member 710, a bottom bracket 712, the linkage 714, one or more stops 716, a pivot joint 718, and a connection point 720. There are also optional dampers 702 connected to the top and bottom brackets 708 and 712. The top bracket 708 may be secured to a torque tube 706 such that the top bracket 708 rotates with the torque tube 706 about an axis of rotation between a first rotational limit in a first direction and a second rotational limit in a second direction. The bottom bracket 712 may be secured to a support column 704. The components depicted in counterbalance assembly 700 may be similar to and perform similar functions as similarly named components described throughout this disclosure.

The stretchable member 710 may be connected at a top end of the stretchable member 710 to the top bracket 708 and may be connected at a bottom end of the stretchable member 710 to the bottom bracket 712. A means for limiting the restorative force applied by a stretchable member 710 may include the linkage 714 positioned between the stretchable member 710 and the top bracket 708 and/or the bottom bracket 712. The linkage 714 may be secured to the top bracket 708 and/or the bottom bracket 712 through the pivot joint 718. The connection point 720 may be a connection between the stretchable member 710 and the linkage 714.

As the torque tube 706 rotates toward the first or second rotational limit, the connection point 720 pivots about the pivot joint 718 in a rotational direction that is opposite to a rotational direction of the torque tube 706. For example, as the torque tube 706 rotates in the first direction (e.g. clockwise) the connection point 720 may pivot about the pivot joint 718 in a direction opposite of the first direction (e.g. counterclockwise), and, as the torque tube 706 rotates in the second direction (e.g. counterclockwise) the connection point 720 may pivot about the pivot joint 718 in a direction opposite of the second direction (e.g. clockwise).

In some embodiments, the stretchable member 710 may be connected to the linkage 714 at the connection point 720 by a bolt, a screw, a nail, a pin, a rivet, a stud, a dowel, a peg, or any other fastener capable of connected the stretchable member 710 to the linkage 714 at the connection point 720. In some embodiments, the stretchable member 710 may be a spring, an elastic cord, a belt, a strap, a tube, a coil, a cable, or any other stretchable member. In embodiments where the stretchable member 710 is a spring, the stretchable member 710 may be a linear spring or a variable-rate spring like a digressive or a progressive spring. In some embodiments, the stretchable member 710 may be a compression spring or a tension spring. In some embodiments, the linkage 714 may be a bar, a chain link, a rod, a lever, an arm, a slider, a cam, a hinge, a swivel, or any other linkage capable of pivoting about a pivot joint.

In some embodiments, the one or more stops 716 may prevent the linkage 714 from moving when the torque tube 706 rotates past a rotational threshold. In some of these embodiments, a first stop 716 may be included on a first side of the linkage 714 and a second stop 716 may be included on a second side of the linkage 714. In some embodiments, the rotational threshold may be less than 45 degrees of rotation (counterclockwise and clockwise), less than 60 degrees of rotation (counterclockwise and clockwise), less than 75 degrees of rotation (counterclockwise and clockwise) or any other rotational threshold or combination of rotational thresholds. In some embodiments, the rotational threshold may be the same in the first direction and the second direction of torque tube rotation. In some embodiments, the rotational threshold may be different in the first direction and the second direction of torque tube rotation. For example, the rotational threshold may be 60 degrees in the counterclockwise direction and 75 degrees in the clockwise direction.

FIGS. 7C and 7D illustrate the example counterbalance assembly 700 at varying tilt angles. FIG. 7C shows the counterbalance assembly 700c at horizontal where the torque tube 706 has not begun rotation in either direction. FIG. 7D shows the counterbalance assembly 700d at a tilt angle where the torque tube 706 has exceeded the rotational threshold and the linkage 714 is prevented from further movement by the one or more stops 716.

At a horizontal tilt angle, the linkage 714 may be vertical as the linkage 714 is positioned in counterbalance assembly 700c. As the torque tube 706 begins to rotate and the tilt angle increases, the connection point 720 between the stretchable member 710 and the linkage 714 may pivot about the pivot joint 718 in a rotational direction that is opposite to a rotational direction of the torque tube 706. For example, as shown in FIG. 7D, the torque tube 706 may rotate in a clockwise direction and the connection point 720 may pivot about the pivot joint 718 in a counterclockwise direction. The counterbalance assembly 700d also includes one or more stops 716 and demonstrates the torque tube 706 rotating past the rotational threshold. As a result, the linkage 714 may contact the one or more stops 716 and the one or more stops 716 may prevent the linkage 714 from continuing to move in an opposite direction as the rotational direction of the torque tube 706.

Modifications, additions, or omissions may be made to the example counterbalance assembly 700 without departing from the scope of the present disclosure. For example, the damper 702 may be omitted. In addition, either or both of the stops 716 shown in FIGS. 7A-7D may be omitted. Additionally, either or both of the top bracket 708 and the bottom bracket 712 may include the linkage 714, the pivot joint 718, and the connection point 720.

FIG. 8 illustrates the effect of the example counterbalance assembly 700 on a restorative force applied by the stretchable member 710 at varying tilt angles. As shown, the starting point is a tilt angle of 0 degrees, which may correspond to the counterbalance assembly 700c of FIG. 7C. At horizontal, the restorative force of the stretchable member 710 may be 0 or negligent because the weight of the modules may be supported by the support column 704 and the torque tube 706 may not have begun rotation at this point.

As the torque tube 706 rotates in the first or second direction, the connection point 720 between the stretchable member 710 and the linkage 714 may pivot about the pivot joint 718 in an opposite direction to the first or second direction. The movement of the connection point 720 may reduce the distance between the center of the torque tube 706 and the force applied by the stretchable member 710 and/or change the angle at which the restorative force of the stretchable member 710 acts on the torque tube 706. Thus, the rate at which the restorative force from the stretchable member 710 increases may be reduced, and the restorative force may be limited to less than a threshold level of force. For example, the threshold level of force may be 1200 N-m and the movement of the connection point 720 may limit the restorative force from the stretchable member 710 below 1200 N-m.

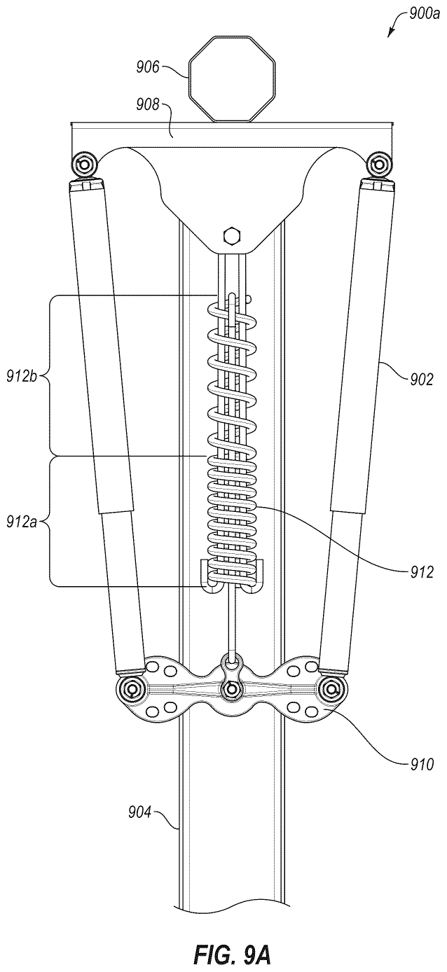

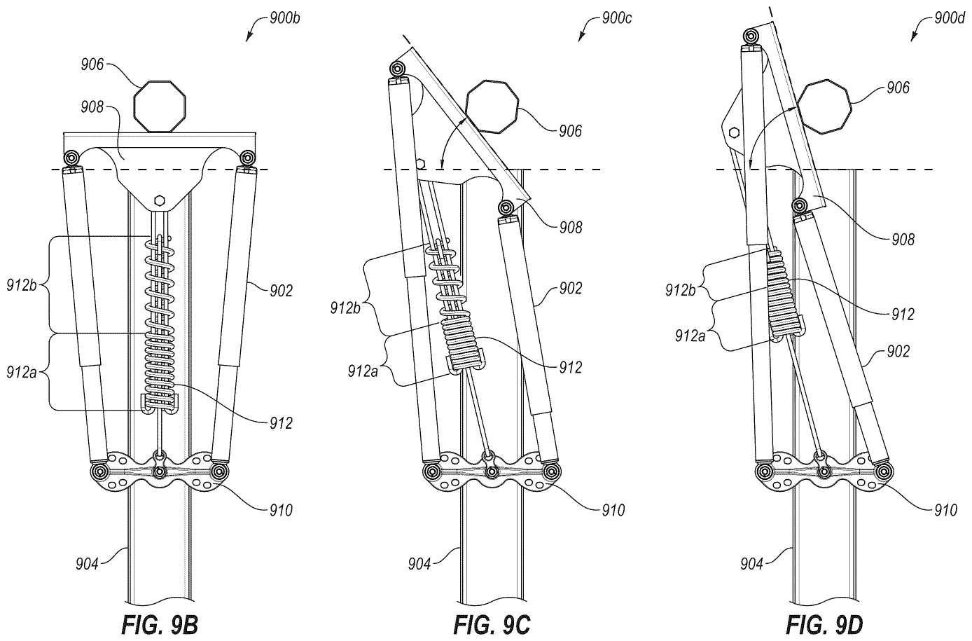

FIG. 9A illustrates a front-view of an example counterbalance assembly 900 utilizing a variable-rate spring 912. The counterbalance assembly 900 may include a top bracket 908, a bottom bracket 910, and the variable-rate spring 912. The top bracket 908 may be secured to a torque tube 906 such that the top bracket 908 rotates with the torque tube 906 about an axis of rotation between a first rotational limit in a first direction and a second rotational limit in a second direction. There are also optional dampers 902 connected to the top and bottom brackets 908 and 910. The bottom bracket 910 may be secured to a support column 904. The components depicted in counterbalance assembly 900 may be similar to and perform similar functions as similarly named components described throughout this disclosure.

The variable-rate spring 912 may include a top end and a bottom end. The top end of the variable-rate spring 912 may be connected to the top bracket 908 and the bottom end of the variable-rate spring 912 may be connected to the bottom bracket 910. The variable-rate spring 912 may have a first spring rate 912a and a second spring rate 912b. The first spring rate 912a may be active from the start of torque tube rotation until an activation angle is reached. The second spring rate 912b may be activated when the activation angle is reached. The first spring rate 912a, the second spring rate 912b, and the activation angle may be configured to maintain a restorative force applied by the variable-rate spring 912 to the torque tube 906 between a minimum restorative force and a maximum restorative force at angles greater than or equal to the activation angle and while the torque tube 906 is between the first and second rotational limits.

The activation angle may be less than 80 degrees, less than 70 degrees, less than 60 degrees, less than 50 degrees, less than 45 degrees, less than 40 degrees, less than 30 degrees, less than 20 degrees, less than 10 degrees, or anywhere in between. The maximum restorative force may be less than 600 N-m, less than 700 N-m, less than 800 N-m, less than 1000 N-m, less than 1100 N-m, less than 1200 N-m, less than 1300 N-m, less than 1400 N-m, less than 1500 N-m, less than 1600 N-m, less than 1700 N-m, less than 1800 N-m, less than 1900 N-m, less than 2000 N-m, or any other restorative force which exceeds the minimum restorative force. The minimum restorative force may be greater than 100 N-m, greater than 150 N-m, greater than 200 N-m, greater than 250 N-m, greater than 300 N-m, greater than 350 N-m, greater than 400 N-m, greater than 450 N-m, greater than 500 N-m, or any other restorative force which is less than the maximum restorative force.

In some embodiments, the variable-rate spring 912 may be a compression spring. In some embodiments, the variable-rate spring 912 may be a tension spring. In some embodiments, the variable-rate spring 912 may be a digressive spring. In these embodiments, the first spring rate 912a may be greater than the second spring rate 912b. In some embodiments, the variable-rate spring 912 may be a progressive spring. In these embodiments, the first spring rate 912a may be less than the second spring rate 912b.

FIG. 9B-9D illustrate the example counterbalance assembly 900 of FIG. 9A at varying tilt angles. FIG. 9B demonstrates the counterbalance assembly 900b at horizontal or 0 degrees, and supported by the support column 904. Thus, the variable-rate spring 912 (shown as a compression spring) is uncompressed.

FIG. 9C demonstrates the counterbalance assembly 900c at a tilt angle less than the activation angle. As shown, the tilt angle is less than the activation angle and so the first spring rate 912a is active and the second spring rate 912b is unactive. Thus, the section of the variable-rate spring 912 corresponding to the second spring rate 912b is uncompressed while the section of the variable-rate spring 912 corresponding to the first spring rate 912a is compressed.

FIG. 9D demonstrates the counterbalance assembly 900d at a tilt angle greater than or equal to the activation angle. Because the tilt angle is greater than or equal to the activation angle, the second spring rate 912b is active. Thus, the section of the variable-rate spring 912 corresponding to the second spring rate 912b is compressed, and the section of the variable-rate spring 912 corresponding to the first spring rate 912a is also compressed.

Modifications, additions, or omissions may be made to the example counterbalance assembly 900 without departing from the scope of the present disclosure. For example, the damper 902 may be omitted. Additionally, although the variable-rate spring 912 is described as having two spring-rates, more than two spring-rates may be utilized. For example, the variable-rate spring 912 may include a third-spring rate which is activated upon reaching a second activation angle. The three spring-rates and the two activation angles may maintain the restorative force applied by the variable-rate spring 912 between a minimum restorative force and a maximum restorative force between.

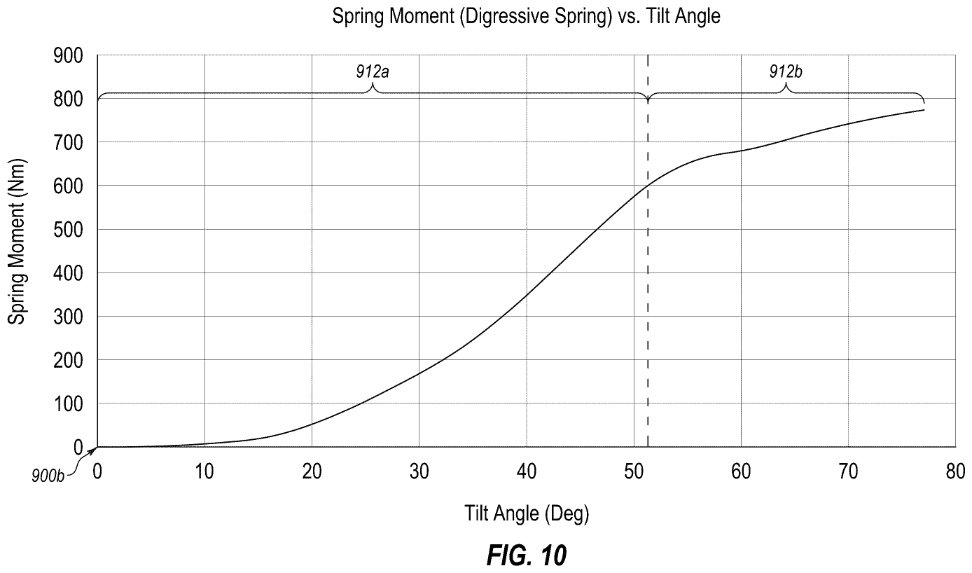

FIG. 10 is a chart showing the effect of the example counterbalance assembly 900 on the restorative force applied by the variable-rate spring 912 where the variable-rate spring 912 is a digressive spring. In embodiments where the variable-rate spring 912 is a digressive spring, the restorative force curve as the tilt angle increases may have a similar shape and profile to FIG. 10.

As shown, the starting point is a tilt angle of 0 degrees, which may correspond to the counterbalance assembly 900b of FIG. 9B. Because the weight of the modules may be supported by the support column 904 and the torque tube 906 may not have begun rotation at this point, each section of the variable-rate spring 912 may be uncompressed and, thus, the restorative force may be 0 N-m or negligible.

As the tilt angle increases and the variable-rate spring 912 begins to compress, the first spring rate 912a may be active. The portion of the curve corresponding to the first spring rate 912a may correspond to the counterbalance assembly 900c of FIG. 9C. Once the activation angle is reached (shown by the dashed line at about 52 degrees), the second spring rate 912b may be active. The portion of the curve corresponding to the second spring rate 912b may correspond to the counterbalance assembly 900d of FIG. 9D. In digressive spring embodiments, the first spring rate 912a may be greater than the second spring rate 912b, which is demonstrated in FIG. 10 by the portion of the curve corresponding to the first spring rate 912a generally having a greater rate of change than the portion of the curve corresponding to the second spring rate 912b.

The first spring rate 912a, the second spring rate 912b, and the activation angle may be configured such that the restorative force applied by the variable-rate spring 912 to the torque tube 906 is maintained between a minimum restorative force and a maximum restorative force at angles greater than or equal to the activation angle. In the example provided by FIG. 10, the activation angle is around 52 degrees, the minimum restorative force may be 600 N-m, and the maximum restorative force may be 900 N-m.

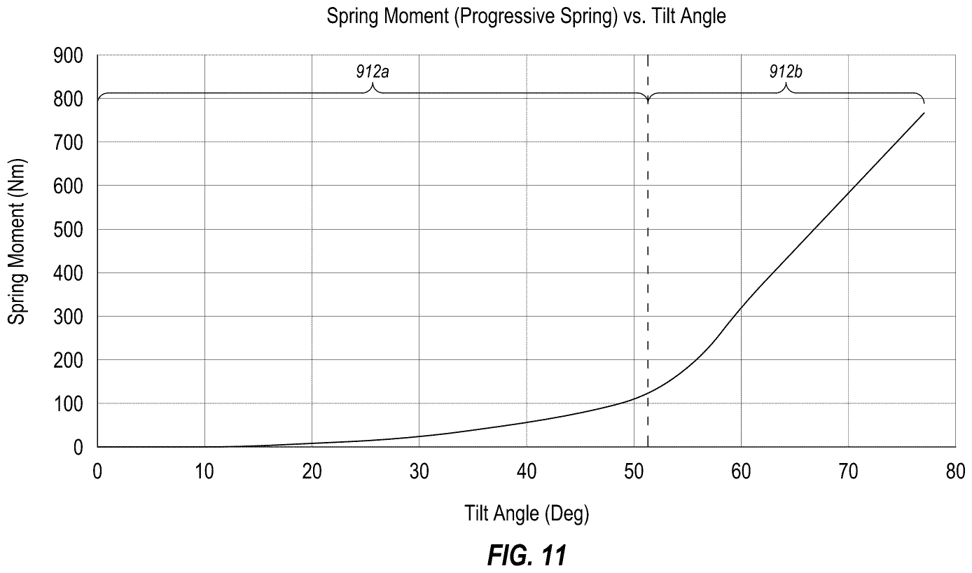

FIG. 11 is a chart showing the effect of the example counterbalance assembly 900 on a restorative force applied by the variable-rate spring 912 where the variable-rate spring 912 is a progressive spring. In embodiments where the variable-rate spring 912 is a progressive spring, the restorative force curve as the tilt angle increases may have a similar shape and profile to FIG. 11.

As shown, the starting point is a tilt angle of 0 degrees. Because the weight of the modules may be supported by the support column 904 and the torque tube 906 may not have begun rotation at this point, each section of the variable-rate spring 912 may be uncompressed and, thus, the restorative force may be 0 N-m or negligible.

As the tilt angle increases and the variable-rate spring 912 begins to compress, the first spring rate 912a may be active. Once the activation angle is reached (shown by the dashed line at about 52 degrees), the second spring rate 912b may be active. In progressive spring embodiments, the first spring rate 912a may be less than the second spring rate 912b, which is demonstrated in FIG. 11 by the portion of the curve corresponding to the first spring rate 912a generally having a lesser rate of change than the portion of the curve corresponding to the second spring rate 912b.

The first spring rate 912a, the second spring rate 912b, and the activation angle may be configured to maintain the restorative force applied by the variable-rate spring 912 to the torque tube 906 between a minimum restorative force and a maximum restorative force at angles greater than or equal to the activation angle. In the example provided by FIG. 11, the activation angle is around 52 degrees, the minimum restorative force may be 100 N-m, and the maximum restorative force may be 900 N-m.

The various features illustrated in the drawings may be, but are not necessarily, drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” among others).

Relative terms used in the present disclosure and especially in the appended claims (e.g., bodies of the appended claims) are generally intended as falling within manufacturing tolerances and/or within scope reasonably understood by a person of skill in the art. For example, if two components are identified as being the “same” size, there may be variations consistent with manufacturing variances. Terms describing “approximately,” “similar,” “substantially,” or other terms designating similarity may convey within ten percent of the comparative value. For example, two components that are approximately the same size would be understood to be of a size within ten percent of each other.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A counterbalance assembly in a photovoltaic (PV) tracking system, the counterbalance assembly comprising:
a top bracket configured to be secured to a torque tube such that the top bracket rotates with the torque tube about an axis of rotation between a first rotational limit in a first direction and a second rotational limit in a second direction;
a bottom bracket configured to be secured to a column supporting the torque tube;
a stretchable member having a top end and a bottom end, the top end being connected to the top bracket and the bottom end being connected to the bottom bracket; and
means for limiting a restorative force applied by the stretchable member to the torque tube to less than a threshold level while the torque tube is between the first and second rotational limits.

2. The counterbalance assembly of claim 1, wherein the first and second rotational limits are the same.

3. The counterbalance assembly of claim 1, wherein the first and second rotational limits are different and the first rotational limit is larger than the second rotational limit.

4. The counterbalance assembly of claim 3, wherein the means for limiting only limits the restorative force applied by the stretchable member to the torque tube in the first direction.

5. The counterbalance assembly of claim 1, wherein at least one of the first rotational limit or the second rotational limit exceeds 70 degrees.

6. The counterbalance assembly of claim 1, wherein the stretchable member is a spring.

7. The counterbalance assembly of claim 1, wherein the threshold level of force is less than 1000 N-m.

8. The counterbalance assembly of claim 1, wherein the means for limiting comprises:
a pin and slot connection where the stretchable member is connected to a pin that is positioned within a slot in at least one of the top bracket or the bottom bracket, wherein the pin and slot connection allows a connection point between the stretchable member and the at least one of the top bracket or the bottom bracket to move within the slot such that a rate at which the restorative force increases as the torque tube rotates toward the first or second rotational limits is reduced.

9. The counterbalance assembly of claim 1, wherein the means for limiting comprises:
a linkage positioned between the stretchable member and at least one of the top bracket or the bottom bracket, wherein the linkage is secured to the at least one of the top bracket or the bottom bracket through a pivot joint such that, as the torque tube rotates toward the first or second rotational limits, a connection point between the stretchable member and the linkage pivots about the pivot joint in a rotational direction that is opposite to a rotational direction of the torque tube.

10. A counterbalance assembly in a photovoltaic (PV) tracking system, the counterbalance assembly comprising:
a top bracket configured to be secured to a torque tube such that the top bracket rotates with the torque tube about an axis of rotation between a first rotational limit in a first direction and a second rotational limit in a second direction;
a bottom bracket configured to be secured to a column supporting the torque tube; and
a stretchable member having a top end and a bottom end, the top end being connected to the top bracket and the bottom end being connected to the bottom bracket, wherein at least one of the top bracket or the bottom bracket includes a pin that is positioned within a slot and the stretchable member is connected to the at least one of the top bracket or the bottom bracket through a pin and slot connection;
wherein the pin and slot connection allows a connection point between the stretchable member and the at least one of the top bracket or the bottom bracket to move within the slot such that a rate at which a restorative force is applied by the stretchable member is reduced as the torque tube rotates toward the first or second rotational limits.

11. The counterbalance assembly of claim 10, wherein the slot is symmetric about a vertical axis.

12. The counterbalance assembly of claim 10, wherein the slot is asymmetric about a vertical axis.

13. The counterbalance assembly of claim 10, wherein the stretchable member is a spring.

14. A counterbalance assembly in a photovoltaic (PV) tracking system, the counterbalance assembly comprising:
a top bracket configured to be secured to a torque tube such that the top bracket rotates with the torque tube about an axis of rotation between a first rotational limit in a first direction and a second rotational limit in a second direction;
a bottom bracket configured to be secured to a column supporting the torque tube;
a stretchable member connected at a top end to the top bracket and at a bottom end to the bottom bracket; and
a linkage positioned between the stretchable member and at least one of the top bracket or the bottom bracket, wherein the linkage is secured to at least one of the top bracket or the bottom bracket through a pivot joint such that, as the torque tube rotates toward the first or second rotational limits, a connection point between the stretchable member and the linkage pivots about the pivot joint in a rotational direction that is opposite to a rotational direction of the torque tube.

15. The counterbalance assembly of claim 14, further comprising one or more stops which prevent the linkage from moving in the rotational direction of the torque tube when the torque tube rotates past a rotational threshold.

16. The counterbalance assembly of claim 15, wherein a first stop is included on a first side of the linkage and a second stop is included on a second side of the linkage.

17. The counterbalance assembly of claim 15, wherein the rotational threshold is less than 45 degrees in a counterclockwise direction of rotation and/or less than 45 degrees in a clockwise direction of rotation.

18. The counterbalance assembly of claim 14, wherein the stretchable member is a spring.

19. The counterbalance assembly of claim 14, wherein:
the linkage is positioned between a top end of the stretchable member and the top bracket,
the top end of the linkage is secured to the top bracket through the pivot joint, and
the connection point is between the top end of the stretchable member and a bottom end of the linkage, wherein:
the connection point rotates in a clockwise direction as the torque tube rotates in a counterclockwise direction and rotates in a counterclockwise direction as the torque tube rotates in a clockwise direction.

20. The counterbalance assembly of claim 14, wherein:
the linkage is positioned between a bottom end of the stretchable member and the bottom bracket,
the bottom end of the linkage is secured to the bottom bracket through the pivot joint, and
the connection point is between the bottom end of the stretchable member and a top end of the linkage, wherein:
the connection point rotates in a clockwise direction as the torque tube rotates in a counterclockwise direction and rotates in a counterclockwise direction as the torque tube rotates in a clockwise direction.
